(19) United States
(12) Patent Application Publication
(10) Pub. No.: US 2026/0316552 A1
(43) Pub. Date: Oct. 15, 2026

(54) Passenger Car Having a Front Luggage Compartment

(71) Applicant: Bayerische Motoren Werke Aktiengesellschaft, Muenchen (DE)

(72) Inventor: Alexander LICHTENBERGER, St. Peter in der Au (AT)

(21) Appl. No.: 19/485,453

(22) PCT Filed: Jun. 28, 2024
(86) PCT No.: PCT/EP2024/068353

§ 371 Date: Nov. 18, 2025

(30) Foreign Application Priority Data
Aug. 1, 2023 (DE) 10 2023 120 376.2

(51) Int. Cl. B60K 11/08; B60R 5/02

(52) U.S. Cl. CPC B60K 11/08; B60R 5/02

(57) ABSTRACT

A passenger car has a front luggage compartment and an air inlet at the front of the vehicle, which air inlet allows ambient air hitting a front face of the front luggage compartment to enter. The front face has at least one air-guiding surface the distance of which from the front of the vehicle increases along a vertical vehicle axis from top to bottom and along a transverse vehicle axis from a center of the front face outwards, so that the air is guided downward and outward along the front face.

### BACKGROUND AND SUMMARY

The invention relates to a passenger car having a front luggage compartment (a so-called frunk) and an air flow in connection with the latter.

FIG. 1 illustrates a front of an electrified motor vehicle 1 from the prior art. In such electrified motor vehicles 1, a very large amount of heat to be dissipated can occur during rapid charging. This thermal energy is usually dissipated via a cooling module 2 (ambient air cooler), frequently using the refrigerating circuit. In order to supply the cooling module 2 with air, a fan 3 is usually used. A portion of the hot air leaving the cooling module 2 is sucked again in front of the cooling module 2 by leaks and other effects. The arrows 4 illustrate such recirculation. This recirculation could be additionally enhanced in the presence of a front luggage compartment 5. This possibly increases a temperature in the cooling circuit and deteriorates a cooling effect. This would have adverse effects, especially in combination with a refrigerating circuit.

It is therefore an object of the present invention to at least partially eliminate the above-mentioned disadvantages.

This object is achieved by a passenger car according to the independent claim(s). Advantageous developments of the invention are the subject of the dependent claims.

According to an exemplary embodiment of the invention, a passenger car is provided, having a front luggage compartment, a so-called frunk; an air inlet at the front of the vehicle, which inlet allows ambient air hitting a front face of the front luggage compartment to enter, wherein the front face has at least one air-guiding surface, the distance of which from the front of the vehicle increases along a vertical vehicle axis from top to bottom and along a transverse vehicle axis from a center of the front face outwards, so that the air is guided downwards and outwards along the front face. By means of this exemplary embodiment, improved air guidance behind the ambient air cooler can be achieved and recirculation of the air, as described at the outset, can be reduced or avoided. This leads to a higher cooling capacity in the cooling and/or refrigerating circuit.

According to a further exemplary embodiment of the invention, the front face of the front luggage compartment is wedge-shaped.

According to a further exemplary embodiment of the invention, a front edge of the wedge shape runs within a plane which is spanned by a vertical vehicle axis and the vehicle longitudinal axis.

According to a further exemplary embodiment of the invention, the wedge shape has two flanks extending from a front edge, which flanks are curved inward and form two air-guiding surfaces.

According to a further exemplary embodiment of the invention, the front face of the front luggage compartment has a thermal insulation.

According to a further exemplary embodiment of the invention, the thermal insulation is formed by means of double-walling, vacuum insulation and/or insulation material.

Hereinafter, a preferred exemplary embodiment of the present invention will be described with reference to the accompanying drawings.

### BRIEF DESCRIPTION OF THE DRAWINGS

FIG. 1 schematically shows a motor vehicle from the prior art;

FIG. 2 schematically shows a passenger car according to an exemplary embodiment of the invention;

FIG. 3a shows schematically a side view of a front luggage compartment of the passenger car from FIG. 2;

FIG. 3b schematically illustrates a front view of the front luggage compartment of the passenger car from FIG. 2; and

FIG. 3c schematically shows a sectional top view of the front luggage compartment of the passenger car from FIG. 2.

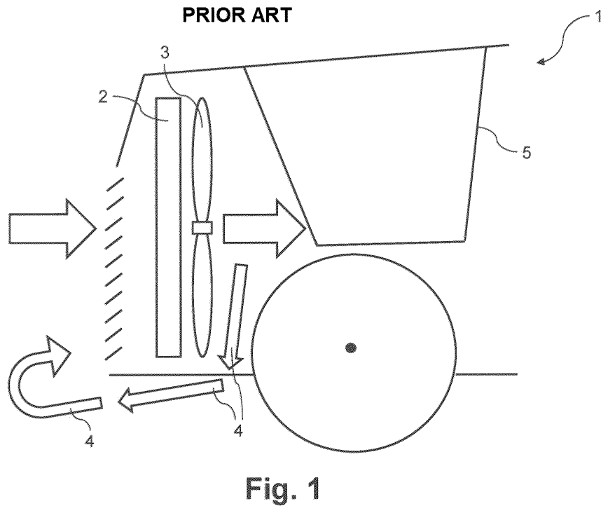

### DETAILED DESCRIPTION OF THE DRAWINGS

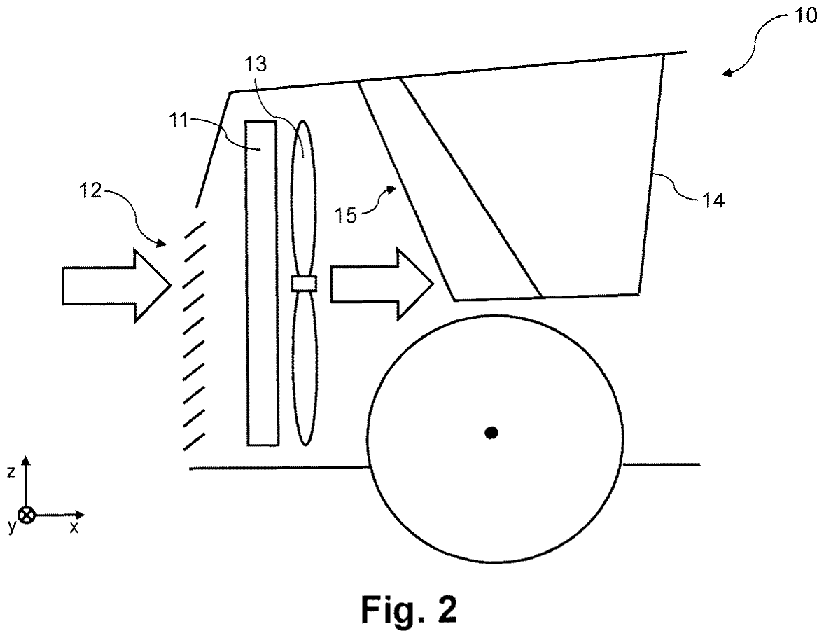

FIG. 2 schematically shows a passenger car 10 according to an exemplary embodiment of the invention. The passenger car 10 is an electrified motor vehicle which is driven purely electrically at least temporarily. At a front end of the passenger car 10, an ambient air cooler 11 is disposed. The ambient air cooler 11 is a heat exchanger through which ambient air can flow and which can flow in a fluidically separated manner from coolant of a refrigerating circuit and/or from refrigerant of a refrigerating circuit.

At the front end of the passenger car 10, in front of the ambient air cooler 11, at least one air inlet 12 is arranged, via which the ambient air can enter and flow to the ambient air cooler 11. A fan 13 is assigned to the ambient air cooler 11, with which fan an air flow can be conveyed through the at least one air inlet 12 and the ambient air cooler 11.

Viewed along a vehicle longitudinal axis x, a front luggage compartment 14 (a so-called frunk) is arranged behind the ambient air cooler 11. Air coming from the ambient air cooler 11 and flowing along the vehicle longitudinal axis x hits the front luggage compartment 14. The front luggage compartment 14 is a luggage storage space which is disposed in front of a vehicle passenger compartment.

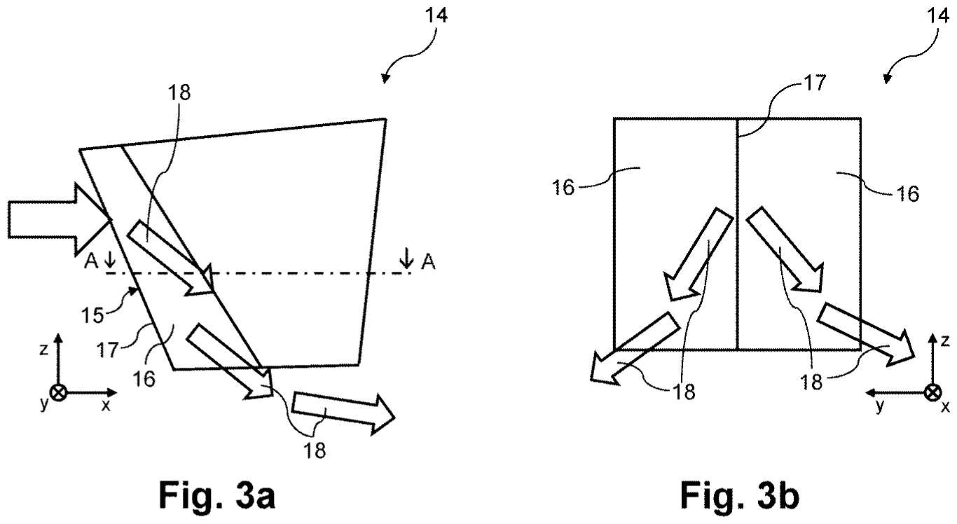

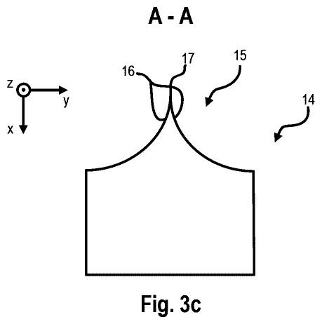

FIG. 3a shows schematically a side view (seen along a transverse vehicle axis y) and FIG. 3b shows a front view (seen along a vehicle longitudinal axis x) of the front luggage compartment 14. In addition, FIG. 3c shows a sectional plan view of the front luggage compartment 14 of the passenger car from FIG. 2, cut along a plane of section A-A from FIG. 3a. This has a front face 15 which forms at least one air-guiding surface 16.

In the exemplary embodiment shown, two air-guiding surfaces 16 are formed on the front face 15. These air-guiding surfaces 16 are generally inclined so as to be closer to the front end of the passenger car 10 at the upper end thereof than at the lower end thereof. Moreover, the front face 15 is wedge-shaped with a wedge shape comprising an edge 17 and two flanks extending therefrom which form the two air-guiding surfaces 16. The edge 17 extends within a plane which is spanned by the vehicle longitudinal axis x and a vertical vehicle axis z. The edge 17 is inclined with respect to the vertical vehicle axis z such that the upper end of the edge 17 is closer to the front end of the passenger car 10 than to the lower end. From this edge 17 the air-guiding surfaces 16 extend outwards and rearwards. The air-guiding surfaces 16 are, for example, planar surfaces or inwardly curved surfaces, as is illustrated by way of example in a sectional plan view in FIG. 3c, so that two air guidance channels running obliquely downwards, rearwards and outwards are formed.

Arrows 18 in FIGS. 3a and 3b illustrate how an air flow hitting the front face 15 is deflected by the air-guiding surfaces 16. Thus, the side view of FIG. 3a shows how the air flow is directed rearwards and down. The front view of FIG. 3b shows how the air flow is guided downwards and outwards.

While the invention has been illustrated and described in detail in the drawings and the foregoing description, this illustration and description is to be understood as exemplary and not limiting, and is not intended to limit the invention to the disclosed exemplary embodiment. The mere fact that certain features are recited in various dependent claims is not intended to indicate that a combination of these features could not also be used advantageously.

1.-6. (canceled)

7. A passenger car, comprising:
a front luggage compartment;
an air inlet located at a front of the vehicle, wherein the air inlet allows ambient air hitting a front face of the front luggage compartment to enter,
wherein the front face of the front luggage compartment has at least one air-guiding surface, a distance of which from the front of the vehicle increases along a vertical vehicle axis from top to bottom and along a transverse vehicle axis from a center of the front face outwards, so that the air is guided downward and outward along the front face.

8. The passenger car according to claim 7, wherein the front face of the front luggage compartment is wedge-shaped.

9. The passenger car according to claim 8, wherein
a front edge of the wedge-shaped front face runs within a plane which is spanned by the vertical vehicle axis and a vehicle longitudinal axis.

10. The passenger car according to claim 8, wherein
the wedge-shaped front face has two flanks which extend from a front edge and are curved inward and form two air-guiding surfaces.

11. The passenger car according to claim 7, wherein the front face of the front luggage compartment has a thermal insulation.

12. The passenger car according to claim 11, wherein the thermal insulation comprises double-walling, vacuum insulation, and/or insulation material.
